(19) United States
(12) Patent Application Publication
(10) Pub. No.: US 2016/0037596 A1
(43) Pub. Date: Feb. 4, 2016

(54) Multi-Stages Power Supplying Control Circuit for Light Emitting Diode

(71) Applicant: NumEn Technology, Inc., Jhubei City (TW)

(72) Inventor: TeCheng Chen, Jhubei City (TW)

(21) Appl. No.: 14/806,726

(22) Filed: Jul. 23, 2015

(30) Foreign Application Priority Data
Aug. 1, 2014 (TW) 103126380

(51) Int. Cl. H05B 33/08

(52) U.S. Cl. CPC H05B 33/083; H05B 33/0812

(57) ABSTRACT

The present invention is relates to a control circuit for LED, especially relates to a multi-stages power supplying control circuit for LED. In the present invention, a diode is set among a plurality of LED units which connect in series. A voltage detecting circuit and a plurality of switching units can be integrated to switch each switching unit after detecting the voltage of the direct current power supply. Thus, the present invention can keep the same outputting power in different input voltage.

### BACKGROUND OF THE INVENTION

1. Field of Invention

The present invention relates to a LED control circuit, and more particularly, the present invention relates to a LED multi-stages power supplying control circuit.

2. Description of Related Art

Recently, energy conservation and carbon reduction of environment-friendly awareness increases gradually. Since LED (Light Emitting Diode) has the characteristics of low energy consumption and high luminous efficiency, so get a good development in luminous field.

In the past, manufacturers research and develop special specifications of LED lamps according to applying locations and fields. However, lamps in the same field still have different power designs in different countries, like vehicles lamps. Thus, manufacturers need to have different design specifications for one kind of lamp, and make costs increase.

In lamps designs of some manufacturers, the switching power is integrated in lamps which configuration as show FIG. 1. The configuration includes a switching power supply circuit 12, a plurality of LED 14, 16, and a current limiter 18. Wherein, the switching power supply circuit 12 is connected in series between the input terminal 101 and the output terminal 103. A plurality of LED 14, 16 and the current limiter 18 are connected in series between the output terminal and the output terminal 103 of the switching power supply circuit 12. The input voltage can be converted to the voltage suited for LED 14, 16 by the switching power supply circuit 12, and the current can be limited in a safe range by the current limiter 18.

Although the configuration of the LED control circuit 10 can be applied in different power conditions or fields, but the switching power supply circuit 12 has larger volume, high costs, and results electromagnetic interference easily. Thus, these problems described above still need to be overcome.

### SUMMARY OF THE INVENTION

Accordingly, an object of the present invention is to provide a LED control circuit, especially relate to a LED multi-stages power supplying control circuit.

Another object of the present invention is to provide a LED multi-stages power supplying control circuit which applies a plurality of switching units to switch the circuit path and achieve the function of constant-power supply.

Another object of the present invention is to provide a LED multi-stages power supplying control circuit which can reduces costs and have no electromagnetic interference.

To achieve the foregoing and other objects, a LED multi-stages power supplying control circuit is provided. The LED multi-stages power supplying control circuit comprises an input terminal and an output terminal, a plurality of LED units, at least a diode, at least an upper switching unit, at least a lower switching unit, and a voltage detecting circuit. The input terminal and the output terminal are connected to a direct current power supply and ground respectively. The LED units include first to (N+1)th LED units which connected in series between the input terminal and the output terminal sequentially. The diodes include first through Nth diodes, each diode is connected in series between the cathode of the corresponding LED unit and the anode of the next stage LED unit respectively. The upper switching units include first through Nth upper switching units, wherein each upper switching unit is connected between the input terminal and the cathode of the corresponding diode respectively. The lower switching units include first through Nth lower switching units, wherein each lower switching unit is connected between the anode of the diode and the output terminal respectively. The voltage detecting circuit is connected in series between the input terminal and the output terminal, and is connected to each upper switching unit and each lower switching unit for detecting the voltage of the direct current power supply, and the upper switching unit and the lower switching unit be set on or off according to the detecting results. Wherein, N being an integer ≧1.

In one embodiment of the multi-stages power supplying control circuit, wherein each LED unit includes a current limiter respectively.

In one embodiment of the multi-stages power supplying control circuit, wherein each switching unit includes a current limiter respectively.

In one embodiment of the multi-stages power supplying control circuit, further including a variable current limiter, the variable current limiter changes the amount of the limited current according to the detecting results by the voltage detecting circuit, wherein the variable current limiter is connected in series between the cathode of (N+1)th LED unit and the output terminal, and is connected to the voltage detecting circuit.

In one embodiment of the multi-stages power supplying control circuit, wherein each diode be replaced by a mid switching unit respectively, each mid switching unit is connected to the voltage detecting circuit respectively and be set on or off according to the detecting results by the voltage detecting circuit.

In one embodiment of the multi-stages power supplying control circuit, wherein the corresponding upper switching unit and the lower switching unit be set on or off simultaneously.

In one embodiment of the multi-stages power supplying control circuit, wherein when the corresponding upper switching unit and the lower switching unit be set on, the corresponding mid switching unit be set off; when the corresponding upper switching unit and the lower switching unit be set off, the corresponding mid switching unit be set on.

In one embodiment of the multi-stages power supplying control circuit, wherein the LED units have the identical or similar operation voltage and operation current. In one embodiment of the multi-stages power supplying control circuit, wherein each LED unit be one LED or one set composed of multiple LED respectively.

The present invention further provides a multi-stages power supplying control circuit for LED which comprises a input terminal and a output terminal, a first LED unit, a second LED unit, a serial-parallel switching module, and a voltage detecting circuit. The input terminal and the output terminal are connected to a direct current power supply and ground respectively. The anode of the first LED unit is connected to the input terminal. The cathode of the second LED unit is connected to the output terminal. The serial-parallel switching module is connected to the cathode of the first LED unit, the anode of the second LED unit, the input terminal, and the output terminal. The voltage detecting circuit is connected in series between the input terminal and the output terminal, and is connected to the serial-parallel switching module for detecting the voltage of the direct current power supply. The serial-parallel switching module is controlled to make the first LED unit and the second LED unit be in series connection or parallel connection according to the detecting results.

In one embodiment of the multi-stages power supplying control circuit, wherein serial-parallel switching module includes a first upper switching unit, a first lower switching unit, a second upper switching unit, and a second lower switching unit. One terminal of the first upper switching unit is connected to the cathode of the first LED unit, another terminal of the first upper switching unit is connected to one terminal of the first lower switching unit, and another terminal of the first lower switching unit is connected to the anode of the second LED unit. One terminal of the second upper switching unit is connected to the cathode of the first LED unit, another terminal of the second upper switching unit is connected to the output terminal, one terminal of the second lower switching unit is connected to the anode of the second LED unit, another terminal of the second lower switching unit is connected to the input terminal. Wherein, each switching unit is connected to the voltage detecting circuit respectively, the switching unit be set on or off by the voltage detecting circuit according to the voltage detecting result of the direct current power supply.

In one embodiment of the multi-stages power supplying control circuit, wherein the corresponding upper switching unit and the lower switching unit be set on or off simultaneously.

In one embodiment of the multi-stages power supplying control circuit, wherein each LED unit be one LED or one set composed of multiple LED respectively.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a conventional LED control circuit.

FIG. 2 is a schematic view illustrating a multi-stages power supplying control circuit according to one embodiment of the present invention.

FIG. 3 is a schematic view illustrating a multi-stages power supplying control circuit according to another embodiment of the present invention.

FIG. 4 is a schematic view illustrating a multi-stages power supplying control circuit according to still another embodiment of the present invention.

FIG. 5 is a schematic view illustrating a multi-stages power supplying control circuit according to still another embodiment of the present invention.

FIG. 6 is a schematic view illustrating a multi-stages power supplying control circuit according to still another embodiment of the present invention.

FIG. 7 is a schematic view illustrating a multi-stages power supplying control circuit according to still another embodiment of the present invention.

FIG. 8 is a schematic view illustrating a multi-stages power supplying control circuit according to still another embodiment of the present invention.

FIG. 9 is a schematic view illustrating a multi-stages power supplying control circuit according to still another embodiment of the present invention.

### DESCRIPTION OF EMBODIMENTS

Other features and advantages of the invention will be further understood from the further technological features disclosed by the embodiments of the invention wherein there are shown and described embodiments of this invention, simply by way of illustration of best modes to carry out the invention.

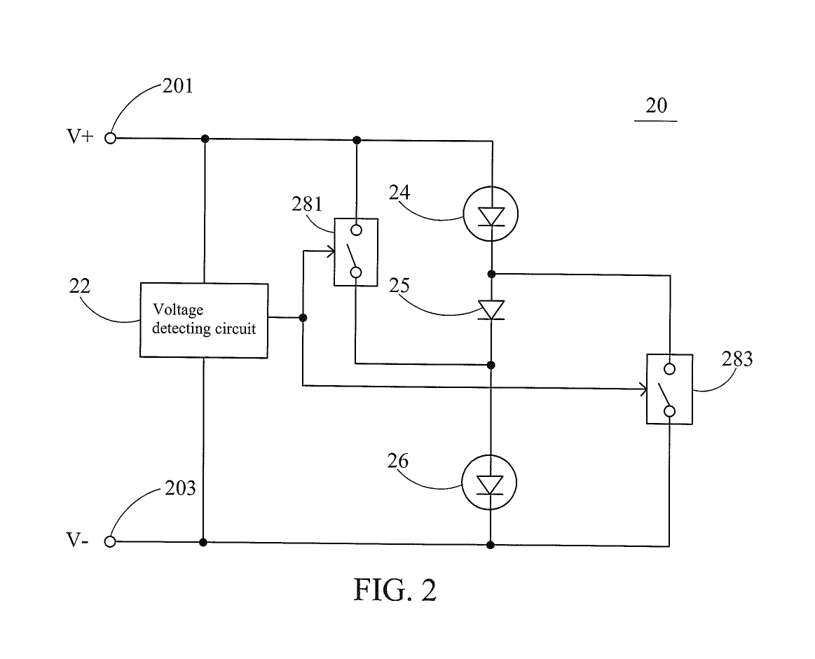

Please refer to FIG. 2 which is a schematic view illustrating a multi-stages power supplying control circuit according to one embodiment of the present invention. A multi-stages power supplying control circuit for LED of the present invention is suitable for multiple LED units and switches between multiple power supply voltages. As shown in FIG. 2, in the present embodiment, the multi-stages power supplying control circuit takes two LED units 24, 26 for example. The multi-stages power supplying control circuit 20 for LED of the present embodiment includes a input terminal 201, a output terminal 203, a voltage detecting circuit 22, a first LED unit 24, a second LED unit 26, a diode 25, a upper switching unit 281, and a lower switching unit 283.

Wherein, the input terminal 201 and the output terminal 203 are connected to a direct current power supply (not shown) and ground respectively. The first LED unit 24 and the second LED unit 26 are connected in series between the input terminal 201 and the output terminal 203 sequentially. The diodes 25 are connected in series between first LED unit 24 and the second LED unit 26. The upper switching unit 281 is connected between the input terminal 201 and the cathode of the diode 25, and the lower switching unit 283 is connected between the anode of the diode 25 and the output terminal 203. The voltage detecting circuit 22 is connected in series between the input terminal 201 and the output terminal 203, and is connected to upper switching unit 281 and the lower switching unit 283 for detecting the voltage of the direct current power supply, and the upper switching unit 281 and the lower switching unit 283 be set on or off according to the detecting results.

In one embodiment of the present invention, the operation voltages of the first LED unit 24 and the second LED unit 26 are set as 12V. In use, when the voltage of the direct current power supply is 24V that detected by the voltage detecting circuit 22, the upper switching unit 281 and the lower switching unit 283 be set off. The first LED unit 24 and the second LED unit 26 are formed in the series connection, suited for 24V.

When the voltage of the direct current power supply is 12V that detected by the voltage detecting circuit 22, the upper switching unit 281 and the lower switching unit 283 be set on, and the first LED unit 24 and the second LED unit 26 are form in the parallel connection, suited for 12V. A diode 25 is disposed between the first LED unit 24 and the second LED unit 26 for inhibiting the reverse voltage and preventing the circuit from malfunctioning.

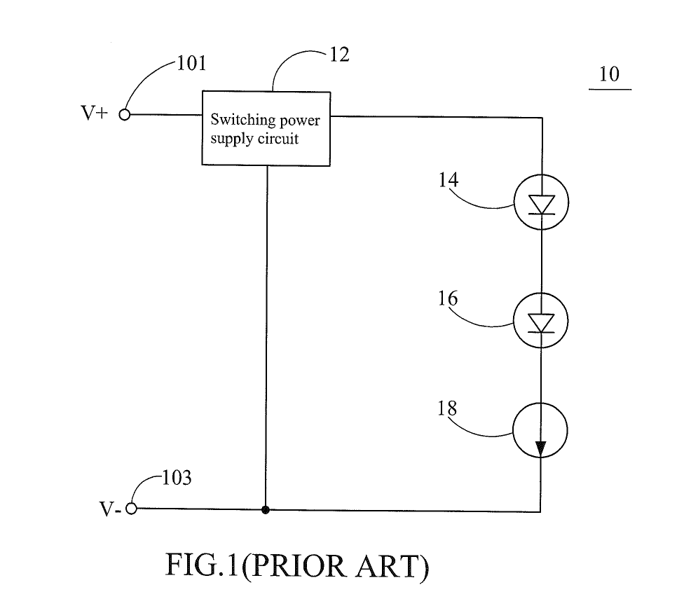

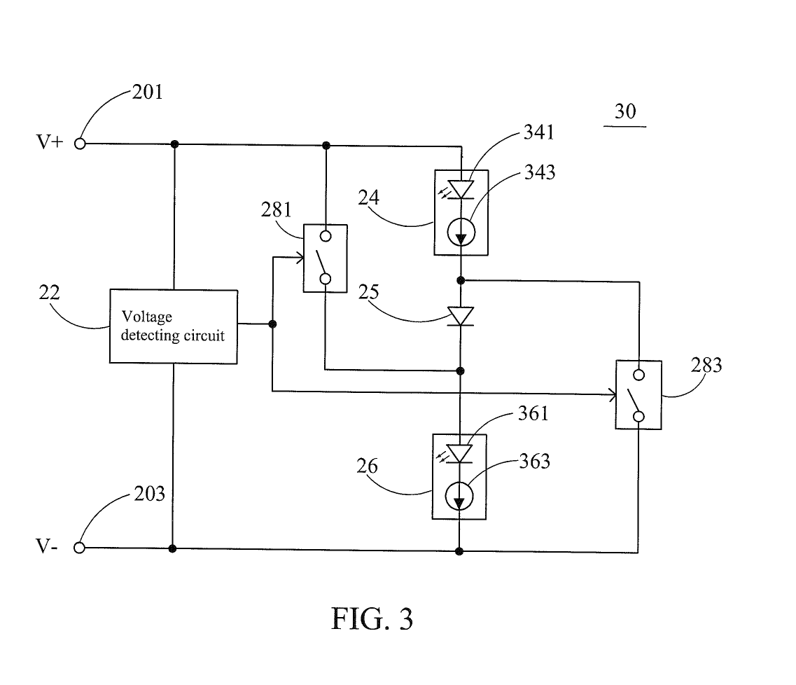

Please refer to FIG. 3 which is a schematic view illustrating a multi-stages power supplying control circuit according to another embodiment of the present invention. As shown in FIG. 3, in the present embodiment, the circuit structure of the multi-stages power supplying control circuit for LED 20 is similar to the embodiment shown in FIG. 1. The difference is that LED unit 24, 26 includes a current limiter 343, 363 respectively.

The first LED unit 24 and the second LED unit 26 of the present embodiment further connect to a current limiter 343, 363 in series respectively except having the LED 341, 361 respectively. When the voltage of the direct current power supply is 24V, the first LED unit 24 and the second LED unit 26 are in series connection, wherein only one of the current limiter 343, 363 which with less current limiting value executes an action. When the voltage of the direct current power supply is 12V, the first LED unit 24 and the second LED units 26 are in parallel connection, the current limiter 343, 363 execute the current limit in the first LED unit 24 and the second LED unit 26 respectively. Thus, when the voltage being half, the integrated current are multiply, and keep the power of the integrated circuit equally.

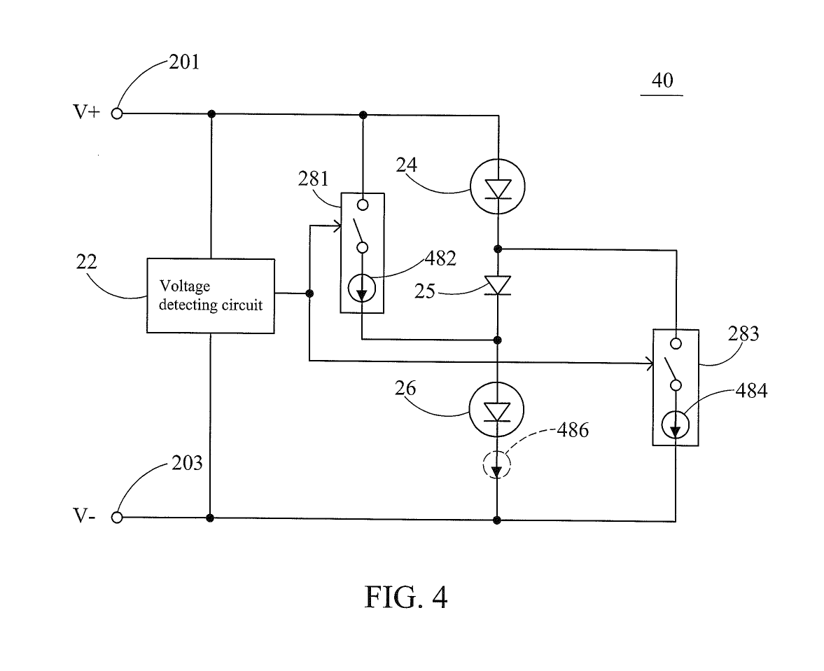

Please refer to FIG. 4 which is a schematic view illustrating a multi-stages power supplying control circuit according to still another embodiment of the present invention. As shown in FIG. 4, in the present embodiment, the circuit structure of the multi-stages power supplying control circuit for LED 40 is similar to the embodiment shown in FIG. 1. The difference is that each switching unit 281, 283 includes a current limiter 482, 484 respectively.

In the upper switching unit 281 and the lower switching unit 283 of the present embodiment, being connected a current limiter 482, 484 in series respectively except having switching element. When the voltage of the direct current power supply is 24V, the first LED unit 24 and the second LED unit 26 are in series connection, the electric current pass through each LED unit 24, 26 directly. When the voltage of the direct current power supply is 12V, the first LED unit 24 and the second LED unit 26 are in parallel connection. The first LED unit 24 and the second LED unit 26 execute the current limit by the current limiter 482, 484 respectively. In addition, a current limiter 486 is still connected in series to the series circuit of LED unit 24 and LED unit 26 for preventing the current too large when the direct current voltage is 24V.

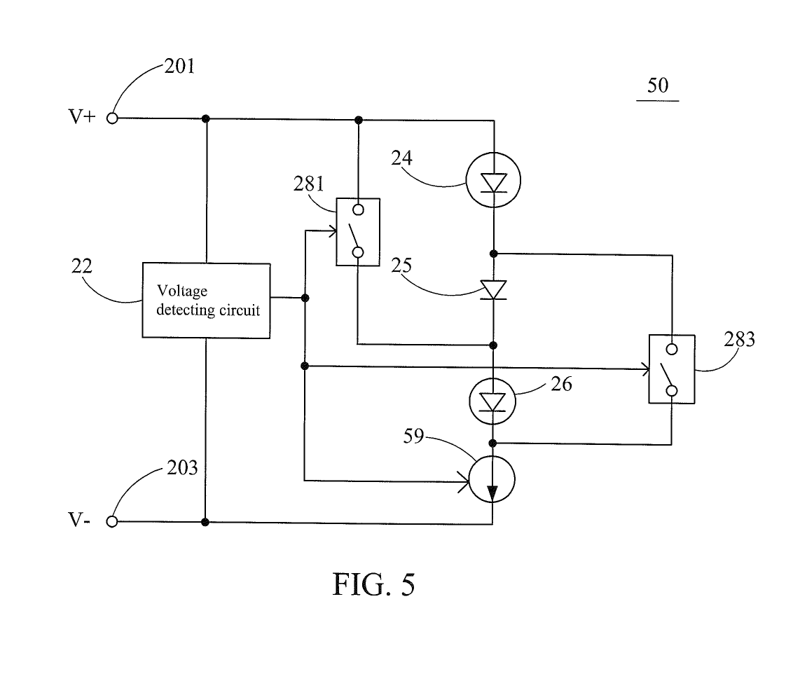

Please refer to FIG. 5 which is a schematic view illustrating a multi-stages power supplying control circuit according to still another embodiment of the present invention. As shown in FIG. 5, in the present embodiment, the circuit structure of the multi-stages power supplying control circuit for LED 50 is similar to the embodiment shown in FIG. 1. The difference is that the circuit structure of the multi-stages power supplying control circuit for LED 50 further includes a variable current limiter 59.

In the present embodiment, the variable current limiter 59 is connected in series between the cathode of the second LED unit 26 and the output terminal 203, and is connected to the voltage detecting circuit 22. When the voltage of the direct current power supply is 24V, the first LED unit 24 and the second LED unit 26 are in series connection. The variable current limiter 59 being made at a first state, wherein the current is limited in 20 mA, for example. When the voltage of the direct current power supply is 12V, the first LED unit 24 and the second LED unit 26 are in parallel connection. The variable current limiter 59 being made at a second state, wherein the current is limited in 40 mA, for example. Therefore, the power of the integrated circuit can be keep equally.

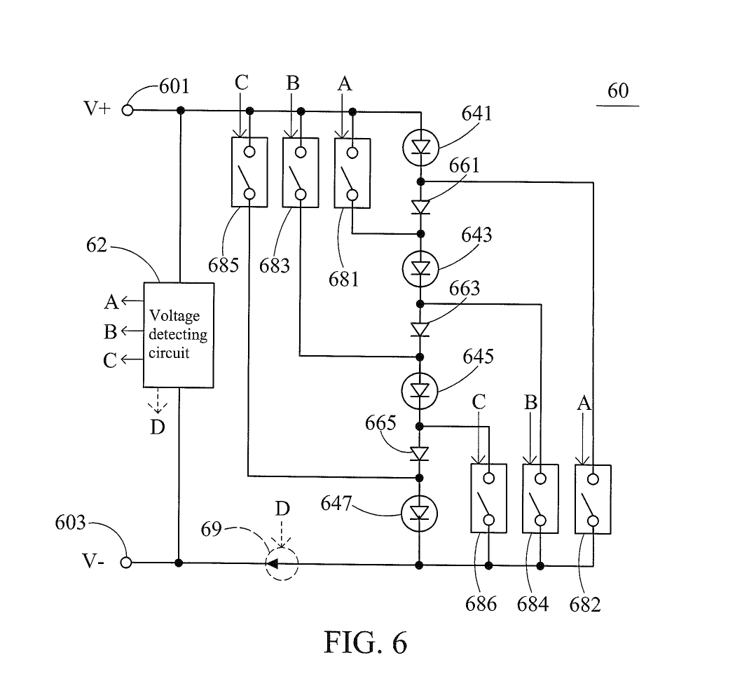

Please refer to FIG. 6 which is a schematic view illustrating a multi-stages power supplying control circuit according to still another embodiment of the present invention. In the present embodiment, the multi-stages power supplying control circuit takes four LED units 641, 643, 645, and 647 for example. As shown in FIG. 6, the multi-stages power supplying control circuit for LED 60 of the present embodiment includes a input terminal 601, a output terminal 603, a voltage detecting circuit 62, first through fourth LED units 641-647, first to third diodes 661-665, first to third upper switching units 681, 683, 685, and first to third lower switching units 682, 684, 686.

Wherein, the input terminal 601 and the output terminal 603 are connected to the direct current power supply (not shown) and ground respectively. First through fourth LED units 641-647 are connected in series between the input terminal 601 and the output terminal 603 sequentially. First through third diodes 661-665 are connected in series between adjacent LED units 641-647 respectively. The first upper switching unit 681 is connected between the input terminal 601 and the cathode of the first diode 661, and the first lower switching unit 682 is connected between the anode of the first diode 661 and the output terminal 603. The second upper switching unit 683 is connected between the input terminal 601 and the cathode of the second diode 663, and the second lower switching unit 684 is connected between the anode of the second diode 663 and the output terminal 603. The third upper switching unit 685 is connected between the input terminal 601 and the cathode of the third diode 665, and the third lower switching unit 686 is connected between the anode of the third diode 665 and the output terminal 603. The voltage detecting circuit 62 is connected in series between the input terminal 601 and the output terminal 603, and is connected to the upper switching unit 681, 683, 685 and the lower switching unit 682, 684, 686 for detecting the voltage of the direct current power supply, and the upper switching unit 681, 683, 685 and the lower switching unit 682, 684, 686 be set on or off according the detecting results.

In one embodiment of the present invention, the operation voltages of the LED unit 641-647 are 12V. In use, when the voltage of the direct current power supply is 48V that detected by the voltage detecting circuit 62, the upper switching unit 681, 683, 685 and the lower switching unit 682, 684, 686 be set off. The LED units 641-647 are formed in series connection, suited for 48V.

When the voltage of the direct current power supply is 24V that detected by the voltage detecting circuit 62, the first and third upper switching unit 681, 685 and the first and third lower switching unit 682, 686 be set off, and the second upper switching unit 683 and the second lower switching unit 684 be set on. Then, the first and the second LED units 641, 643 are formed in series connection, and the third and fourth LED units 645, 647 are formed in series connection, wherein the two series connections of the LED units are formed in parallel connection, suited for 24V.

When the voltage of the direct current power supply is 12V that detected by the voltage detecting circuit 62, the upper switching unit 681, 683, 685 and the lower switching unit 682, 684, 686 be set on. The LED units 641-647 are formed in parallel connection, suited for 12V.

In the above embodiments as shown in FIG. 3-5, the current limiter can set in the LED units 641-647, the switching unit 681-686 respectively, or a variable current limiter 69 can set between the cathode of the last stage LED unit 647 and the output terminal 603, and changes the amount of the limited current according to the detecting results by the voltage detecting circuit 62.

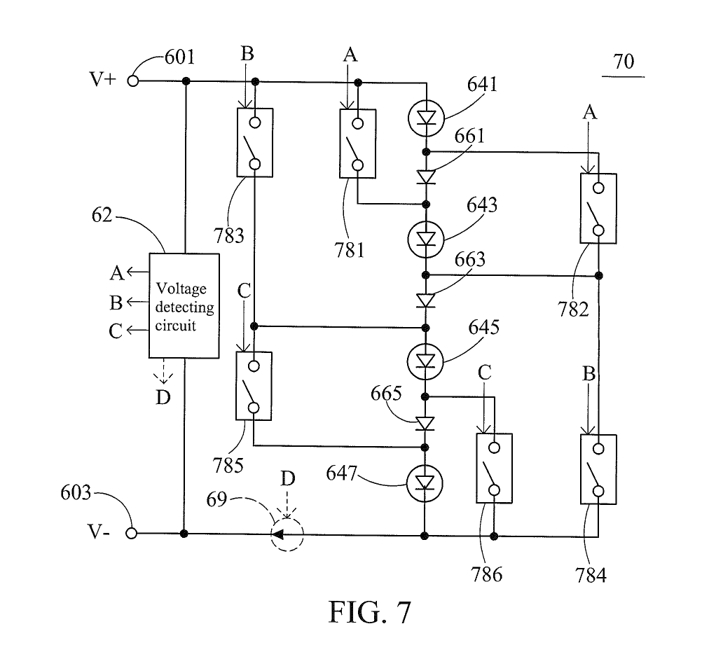

Please refer to FIG. 7 which is a schematic view illustrating a multi-stages power supplying control circuit according to still another embodiment of the present invention. As shown in FIG. 7, in the present embodiment, the circuit structure of the multi-stages power supplying control circuit for LED 70 is similar to the embodiment shown in FIG. 6. The difference is that the connecting mode of the switching units 781-786 has some slight difference.

The first upper switching unit 781 of the present embodiment is connected between the input terminal 601 and the cathode of the first diode 661, the first lower switching unit 782 is connected between the anode of the first diode 661 and the anode of the second diode 663. The second upper switching unit 783 is connected between the input terminal 601 and the cathode of the second diode 663, the second lower switching unit 784 is connected between the anode of the second diode 663 and the output terminal 603. The third upper switching unit 785 is connected between the cathode of the second diode 663 and the cathode of the third diode 665, and the third lower switching unit 786 is connected between the anode of the third diode 665 and the output terminal 603.

When the voltage of the direct current power supply is 48V that detected by the voltage detecting circuit 62, the upper switching unit 781, 783, 785 and the lower switching unit 782, 784, 786 be set off The LED units 641-647 are formed in series connection, suited for 48V.

When the voltage of the direct current power supply is 24V that detected by the voltage detecting circuit 62, the first and third upper switching units 781, 785 and the first and third lower switching unit 782, 786 be set off, and the second upper switching unit 783 and the second lower switching unit 784 be set on. Then, the first and the second LED unit 641, 643 are formed in series connection, and the third and fourth LED unit 645, 647 are formed in series connection. The two series connections of LED units are formed in parallel connection, suited for 24V.

When the voltage of the direct current power supply is 12V that detected by the voltage detecting circuit 62, the upper switching units 781, 783, 785 and the lower switching units 782, 784, 786 be set on. The LED units 641-647 are formed in parallel connection, suited for 12V.

Thus, the above or other modes by changing the connection of the switching units to achieve the effects of the serial-parallel circuit are included within the scope of the present invention.

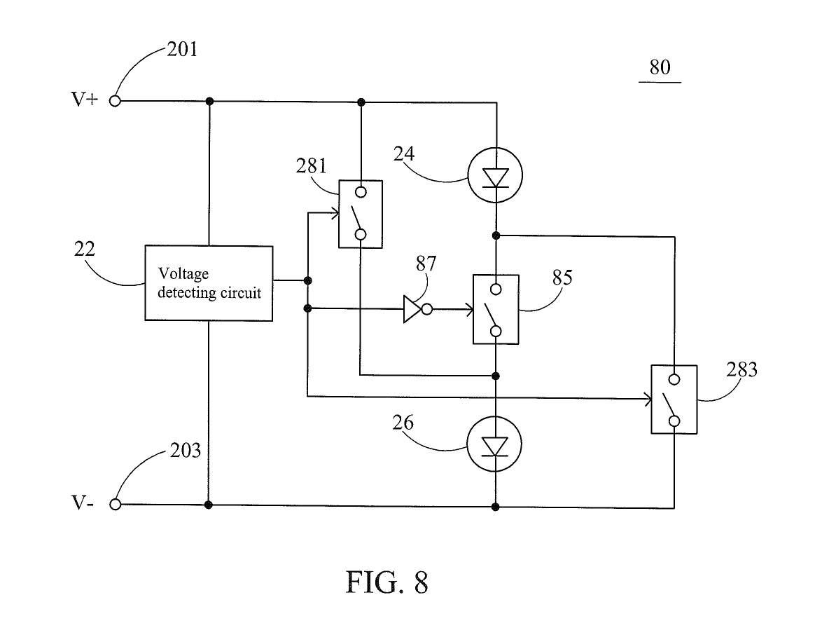

Please refer to FIG. 8 which is a schematic view illustrating a multi-stages power supplying control circuit according to still another embodiment of the present invention. As shown in FIG. 8, in the present embodiment, the circuit structure of the multi-stages power supplying control circuit for LED 80 is similar to the embodiment shown in FIG. 2. The difference is that the diode 25 is replaced by a mid switching unit 85 in the present embodiment.

In the present embodiment, a mid switching unit 85 is set between the first LED unit 24 and the second LED unit 85. The mid switching unit 85 is connected to the voltage detecting circuit 22, and be set on or off according the voltage detecting results of the direct current power supply.

When the voltage of the direct current power supply is 24V that detected by the voltage detecting circuit 22, the upper switching unit 281 and the lower switching unit 283 be set off, and the mid switching unit 85 be set on. The first LED unit 24 and the second LED unit 26 are formed in series connection, suited for 24V.

When the voltage of the direct current power supply is 12V that detected by the voltage detecting circuit 22, the upper switching unit 281 and the lower switching unit 283 be set on, and the mid switching unit 85 be set off. Then, the first LED unit 24 and the second LED unit 26 are formed in parallel connection, suited for 12V, wherein a disconnection can be formed between the first LED unit 24 and the second LED unit 26 by the mid switching unit 85 to prevent the circuit from malfunctioning.

From the above operations, in the present invention, the corresponding upper switching unit and lower switching unit be set on or off simultaneously. The state of the mid switching unit 85 is contrast to the state of the corresponding upper switching unit 281 and the lower switching unit 283. Thus, the signals for controlling the upper switching unit 281 and the lower switching unit 283 can be inverted by a inverter 87, and then connects to the mid switching unit 85 for controlling.

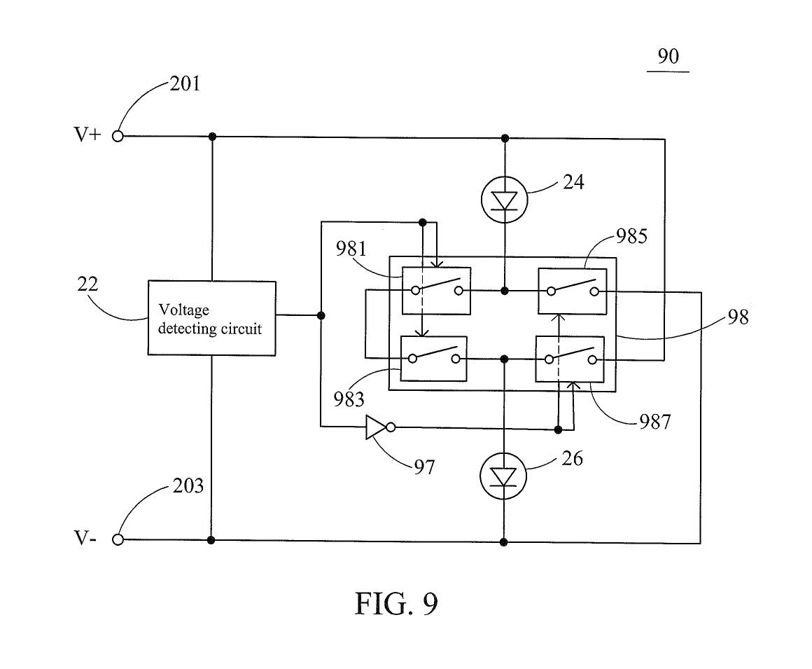

Please refer to FIG. 9 which is a schematic view illustrating a multi-stages power supplying control circuit according to still another embodiment of the present invention. As shown in FIG. 9, in the present embodiment, the circuit structure of the multi-stages power supplying control circuit for LED 90 is similar to the embodiment shown in FIG. 2. The difference is that the present embodiment switches the serial-parallel connection of the circuit by using a serial-parallel switching module 98.

In the present embodiment, the serial-parallel switching module 98 is connected to the cathode of the first LED unit 24, the anode of the second LED unit 26, the input terminal 201, and the output terminal 203, and is connected to the voltage detecting circuit 22. The voltage detecting circuit 22 can detect the voltage of the direct current power supply, and switches the serial-parallel switching module to make the first LED unit 24 and the second LED unit 26 be in series connection or parallel connection according to the detecting results.

In one embodiment of the present invention, the serial-parallel switching module 98 includes a first upper switching unit 981, a first lower switching unit 983, a second upper switching unit 985, and the second lower switching unit 987. Wherein, one terminal of the first upper switching unit 981 is connected to the cathode of the first LED unit 24, another terminal of the first upper switching unit 981 is connected to one terminal of the first lower switching unit 983, and another terminal of the first lower switching unit 983 is connected to the anode of the second LED unit 26. One terminal of the second upper switching unit 985 is connected to the cathode of the first LED unit 24, another terminal of the second upper switching unit 985 is connected to the output terminal 203, one terminal of the second lower switching unit 987 is connected to the anode of the second LED unit 26, and another terminal of the second lower switching unit 987 is connected to the input terminal 201. The switching units 981-987 are connected to the voltage detecting circuit 22 respectively, and the switching units 981-987 be set on or off according to the voltage detecting results of the direct current power supply.

By using the serial-parallel switching module 98, when the detecting voltage of the power supply voltage is 24V, the first upper switching unit 981 and the first lower switching unit 983 be set on, and the second upper switching unit 985 and the second lower switching unit 987 be set off. Then, the first LED unit 24 and the second LED unit 26 are in series connection, suited for 24V.

When the detecting voltage of the power supply voltage is 12V, the first upper switching unit 981 and the first lower switching unit 983 be set off, and the second upper switching unit 985 and the second lower switching unit 987 be set on. Then, the first LED unit 24 and the second LED unit 26 are in parallel connection, suited for 12V.

In one embodiment of the present invention, the serial-parallel switching module 98 can be implement by applying one mechanical type slide switch which be switched according the judgment of a user without the voltage detecting circuit 22.

In the above embodiments of the present invention, the LED units have the identical or similar operation voltage and operation current respectively. Each LED unit be one LED or one set composed of multiple LED respectively. Wherein, the current limiter can be replaced by a constant current component, and achieves more accurate effects for current controlling.

The above embodiments although just take examples of two LED units and four LED units, but the embodiments of three LED units or more LED units can be understood based on the above implement principles.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. A multi-stages power supplying control circuit for LED, comprising:
an input terminal and an output terminal, connected to a direct current power supply and ground respectively;
a plurality of LED units, including first through (N+1)th LED units, wherein each LED unit is connected in series between the input terminal and the output terminal sequentially;
at least a diode, including first through Nth diodes, wherein each diode is connected in series between the cathode of the corresponding LED unit and the anode of the next stage LED unit respectively;
at least a upper switching unit, including first through Nth upper switching units, wherein each upper switching unit is connected between the input terminal and the cathode of the corresponding diode respectively;
at least a lower switching unit, including first through Nth lower switching units, wherein each lower switching unit is connected between the anode of the diode and the output terminal respectively; and
a voltage detecting circuit, connected in series between the input terminal and the output terminal, and connected to each upper switching unit and each lower switching unit for detecting the voltage of the direct current power supply, and each upper switching unit and each lower switching unit be set on or off according to the detecting results;
wherein, N being an integer ≧1.

2. The multi-stages power supplying control circuit of claim 1, wherein each LED unit includes a current limiter respectively.

3. The multi-stages power supplying control circuit of claim 1, wherein each switching unit includes a current limiter respectively.

4. The multi-stages power supplying control circuit of claim 1, further including a variable current limiter, changing the amount of the limited current according to the detecting results by the voltage detecting circuit, wherein the variable current limiter is connected in series between the cathode of (N+1)th LED unit and the output terminal, and connected to the voltage detecting circuit.

5. The multi-stages power supplying control circuit of claim 1, wherein each diode be replaced by a mid switching unit respectively, each mid switching unit is connected to the voltage detecting circuit respectively and be set on or off according to the detecting results by the voltage detecting circuit.

6. The multi-stages power supplying control circuit of claim 1, wherein the corresponding upper switching unit and the lower switching unit be set on or off simultaneously.

7. The multi-stages power supplying control circuit of claim 5, wherein when the corresponding upper switching unit and the lower switching unit be set on, the corresponding mid switching unit be set off; when the corresponding upper switching unit and the lower switching unit be set off, the corresponding mid switching unit be set on.

8. The multi-stages power supplying control circuit of claim 1, wherein the LED units have the identical or similar operation voltage and operation current.

9. The multi-stages power supplying control circuit of claim 1, wherein each LED unit be one LED or one set composed of multiple LED respectively.

10. A multi-stages power supplying control circuit for LED, comprising:
an input terminal and an output terminal, connected to a direct current power supply and ground respectively;
a first LED unit, the anode of the first LED unit is connected to the input terminal;
a second LED unit, the cathode of the second LED unit is connected to the output terminal;
a serial-parallel switching module, connected to the cathode of the first LED unit, the anode of the second LED unit, the input terminal, and the output terminal; and
a voltage detecting circuit, connected in series between the input terminal and the output terminal, and connected to the serial-parallel switching module for detecting the voltage of the direct current power supply, and the serial-parallel switching module is controlled to make the first LED unit and the second LED unit be in series connection or parallel connection according to the detecting results.

11. The multi-stages power supplying control circuit of claim 10, wherein the serial-parallel switching module including:
a first upper switching unit and a first lower switching unit, one terminal of the first upper switching unit is connected to the cathode of the first LED unit, another terminal of the first upper switching unit is connected to one terminal of the first lower switching unit, and another terminal of the first lower switching unit is connected to the anode of the second LED unit; and
a second upper switching unit and a second lower switching unit, one terminal of the second upper switching unit is connected to the cathode of the first LED unit, another terminal of the second upper switching unit is connected to the output terminal, one terminal of the second lower switching unit is connected to the anode of the second LED unit, another terminal of the second lower switching unit is connected to the input terminal;
wherein, each switching unit is connected to the voltage detecting circuit respectively, the switching unit be set on or off by the voltage detecting circuit according to the voltage detecting result of the direct current power supply.

12. The multi-stages power supplying control circuit of claim 11, wherein the corresponding upper switching unit and the lower switching unit be set on or off simultaneously.

13. The multi-stages power supplying control circuit of claim 10, wherein each LED unit be one LED or one set composed of multiple LED respectively.
